(19) United States
(12) Patent Application Publication
(10) Pub. No.: US 2017/0361346 A1
(43) Pub. Date: Dec. 21, 2017

(54) MASKLESS PAINTING AND PRINTING

(71) Applicant: Airbus Operations GmbH, Hamburg (DE)

(72) Inventors: Daniel LAHIDJANIAN, Hamburg (DE); Matthias OTTO, Hamburg (DE); Peter LINK, Hamburg (DE); Philipp VON SCHROEDER, Hamburg (DE); Rolf BENSE, Hamburg (DE); Bernd SASSE, Hamburg (DE)

(21) Appl. No.: 15/621,390

(22) Filed: Jun. 13, 2017

(30) Foreign Application Priority Data
Jun. 16, 2016 (EP) 16174811.6

(51) Int. Cl. B05B 13/04; B05B 7/06; B05D 1/02; B05B 13/06; B05B 7/02; B41J 3/407; B05C 1/02; B05B 13/02

(52) U.S. Cl. CPC B05B 13/0431; B05B 13/0636; B05B 7/062; B05B 7/025; B05D 1/02; B05C 1/027; B05B 13/0242; B41J 3/4073

(57) ABSTRACT

An apparatus (and a corresponding operation method) for automated maskless painting of an external paint on a complex surface using a coloring agent, wherein the complex surface is part of an aircraft. The apparatus comprises a multi-axis robot comprising at least one applicator for the coloring agent, wherein the at least one applicator is configured to apply the coloring agent to the complex surface using a coloring agent ejection technology.

### CROSS-REFERENCES TO RELATED APPLICATIONS

This application claims the benefit of the European patent application No. 16174811.6 filed on Jun. 16, 2016, the entire disclosures of which are incorporated herein by way of reference.

### BACKGROUND OF THE INVENTION

The present disclosure generally relates to automated maskless painting. In particular, the present disclosure relates to automated maskless painting of an external paint on a complex surface using a coloring agent, wherein the complex surface is part of an aircraft.

Nowadays, efficiency of coating applications becomes more and more important. Conventional technologies like spraying, for example, have often big problems with overspray of painting material. This behavior results from a high degree of atomization of the paints, which is accompanied with a very fine spray. Problematically, the portion of sprayed paint does not get to the desired area. To secure specific areas from paint and to get selective, sharp paint results, non-added value process steps like masking are needed. Furthermore, overspray leads to a high amount of material waste and low transfer efficiency. As a consequence of these effects, there is an increased filter loading and higher levels of emission during the painting process. These emissions must be removed by a high amount of cabin air stream, which increases total energy consumption of the painting application. Especially in aerospace and ship industries, these factors play an important role, because a lot of manual work has to be performed during painting processes. This results in significant effort for employment protection as well.

In this regard, selective paintings like markings, letters or pictures need several manual masking/demasking steps before and after the painting. These steps cost a lot of time and money as well. With these aspects in mind, it makes sense to research technologies that bring about proper solutions with these problems. The so called “Maskless Painting Technology” provides an interesting alternative to the previous conventional spraying processes. Among these technologies, primarily different techniques are summarized, which allow painting of selective areas or lines without a masking step before. Additionally, only the paint material which is needed for the coating will be applied. Thus, there is a non-overspray process.

With this background, the present applicants decided to make an over-view study on two specific applications cases, which are currently of high interest:

Application of Wear Resistant Paint (WRP) on final topcoat on external surfaces (e.g. landing flaps).

Application of decoration processes including application of technical markings on external surfaces of aircraft parts (e.g., Sharklets®, Vertical Tail Plane (VTP)).

However, through previous experience with so-called direct printing, limits in its application arise. Still further, there is demand for reduction of non-added value processes (such as masking) before painting in order to enable and cover rate increase.

In this regard, it must be noted that the previous technology cannot be used on extremely curved surfaces or in overhead position. That is why the previous technology can be used on VTP only. Further, the previous technology is only able to apply inks, and is not able to print some of the existing paints.

Accordingly, there is a need for an implementation of a scheme that avoids one or more of the problems discussed above, or other related problems.

### SUMMARY OF THE INVENTION

In a first aspect, there is provided an apparatus for automated maskless painting of an external paint on a complex surface using a coloring agent, wherein the complex surface is part of an aircraft, comprising a multi-axis robot comprising at least one applicator for the coloring agent, wherein the at least one applicator is configured to apply the coloring agent to the complex surface using a coloring agent ejection technology. In this way, both paints and inks can be applied, and also complex surfaces of an aircraft can be painted.

In a first refinement of the first aspect, the applicator may be one of an electrostatic spray gun, and a rotary-bell spray painting applicator. Accordingly, the present disclosure can be implemented exploiting existing technologies as far as possible.

In a second refinement of the first aspect, the at least one applicator may comprise a plurality of applicators mounted in parallel to one another. In this way, the painting process is accelerated.

In a third refinement of the first aspect, the coloring agent may be one of paints and inks. In addition or alternatively, the external paint may be one of an external primer, a base coat, a topcoat, a decoration coating, a clear coat, a functional coating, and a wear resistant paint on a final top coat. Further, in addition or alternatively, the part of the aircraft may be one of a vertical tail plane, a flap, at least a portion of the fuselage of the aircraft, at least a portion of a wing of the aircraft, and at least a portion of a nacelle of the aircraft. Accordingly, any part of the aircraft can be high-precision coated with any coatings necessary.

In a fourth refinement of the first aspect, the coloring agent ejection technology may be a piezoelectric jet valve technology. Accordingly, a technique is implemented, which can handle a vast variety of coloring agents (i.e., different viscosities and particle sizes).

In a fifth refinement of the first aspect, the coloring agent ejection technology may be a flush-out fluid ejecting technology. In this regard, a technique is presented, which can handle especially paints having high viscosity and being based on thixotropic pigments.

In a sixth refinement of the first aspect, the coloring agent ejection technology may be an inkjet technology. Here, a non-impact printing method having high structural resolution, high printing speed and versatile coloring agents is realized.

In a seventh refinement of the first aspect, the coloring agent ejection technology may be an oscillated monodisperse droplet generation. Accordingly, strong repeatability in generation of equal-sized droplets is attained.

In an eighth refinement of the first aspect, the coloring agent ejection technology may be an ultrasonic vibrating nozzle inkjet technology. Here, a technique having high throughput is realized.

In a second aspect, there is provided a method for automated maskless painting of an external paint on a complex surface using a coloring agent, wherein the complex surface is part of an aircraft and wherein a multi-axis robot comprising at least one applicator for the coloring agent is used, the method comprising the step of applying, by the at least one applicator, the coloring agent to the complex surface using a coloring agent ejection technology.

Still further, it is to be noted that the method aspects may also be embodied on the apparatus of the first aspect comprising at least one processor and/or appropriate means so as to implement the control-related aspects.

### BRIEF DESCRIPTION OF THE DRAWINGS

The embodiments of the technique presented herein are described herein below with reference to the accompanying drawings, in which:

FIG. 1 shows an example arrangement of the apparatus according to the present disclosure;

FIG. 2A shows configurations for Drop on Demand (DOD) thermal inkjet printheads;

FIG. 2B shows drop generation with a piezo driven DOD system;

FIG. 2C shows a principle of operation of a single and a multiple continuous inkjet system;

FIG. 2D shows test print using inkjet technology;

FIG. 3A shows a principle of oscillated monodisperse droplet generation with use of Rayleigh decay of laminar fluid jets after introducing vibratory disturbances;

FIG. 3B shows functional design of a droplet applicator;

FIG. 4A shows the drop ejection principle of ultrasonic vibrating nozzle inkjet;

FIG. 4B shows a so-called Vista Print head schematic;

FIG. 4C shows the Vista inkjet system printing conventional paints;

FIG. 5A shows a schematic drawing of a Piezo Jet Valve;

FIG. 5B shows a principle of fluid application with a piezoelectric jet valve;

FIG. 6A shows a schematic drawing of a Push-Out Fluid Ejector with its functional parts;

FIG. 6B shows the four phases of drop generation with the Push-Out Fluid Ejector;

FIG. 6C shows different possible fluid ejectors in relation to the Push-Out Fluid Ejector;

FIG. 7A shows an alternative technology, here a selective paint coating with powder airbrush;

FIG. 7B shows a further alternative technology, here an electrophotography process;

FIG. 7C shows a further alternative technology, here a laser-sonic technology;

FIG. 8 shows a method embodiment which also reflects the interaction between the components of the device embodiment;

FIG. 9A shows the flow curves for Desothane CA 9100 and for Alexit H/S Basecoat 411-22 Black; and

FIG. 9B shows the viscosity curve of the tested Alexit H/S Basecoat 411-22 of FIG. 9A being zoomed in.

### DETAILED DESCRIPTION OF THE PREFERRED EMBODIMENTS

In the following description, for purposes of explanation and not limitation, specific details are set forth (such as particular signaling steps) in order to provide a thorough understanding of the technique presented herein. It will be apparent to one skilled in the art that the present technique may be practiced in other embodiments that depart from these specific details.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP) or general purpose computer. It will also be appreciated that while the following embodiments are described in the context of methods and devices, the technique presented herein may also be embodied in a computer program product as well as in a system comprising a computer processor and a memory coupled to the processor, wherein the memory is encoded with one or more programs that execute the services, functions and steps disclosed herein.

In this regard, the present disclosure may be summarized as follows (this does not preclude certain broadenings in the subsequent description):

Applying aircraft paintings and inks with non-overspray for customized logos, technical markings and zonings, lettering and limited specific areas on very complex geometries like the fuselage is a very attractive method for reducing the process time in painting. The complete masking process before ink and paint application could be eliminated.

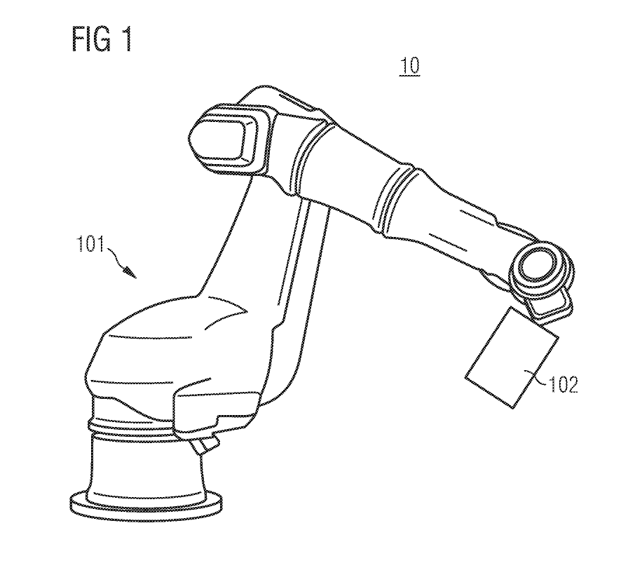

As shown in FIG. 1, the approach of using a multi-axis robot 101 is the next step of evolution in the application of ink and paint printing on aeronautical surfaces. Especially for application on VTP, a printing unit led by a simple gantry unit has already been developed. Here, no flexibility is given for overhead application or application of extremely curved surfaces, which the present disclosure overcomes.

The printing and jet technology principle is applied to existing aircraft paints or inks on complex Aircraft components and geometries. Integration of this technology which can be mounted directly on a multi-axis robot.

To improve and enhance the area efficiency, the printing and jet technology can be expanded by several more printing jets 102 (e.g., mounted in parallel to each other).

Fields of application: Every decorative and functional coating for customized logos and pictures, lettering, technical markings and zonings and specific limited areas which need to be protected with functional coating. Both fields of application require non-overspray paint application with sharp edges fulfilling the external painting requirements.

The printing and jet technology principle can be used for creating the customized logos, technical markings and zonings, lettering on the aircraft and specific limited areas which require functional coatings. The place of application could be the paint-shop.

The used paint and/or inks should be, e.g., external paints like topcoat, base coat, functional coatings.

In industry there are, in dependence of the operation purpose, many different coating methods available. From simple blade coating over to screen printing or airless spraying applications, a lot of different technologies are used, in each case fitting for the best results. According to given requirements, some “classical” principles in the industrial sector have proven themselves and are well established over the years. For instance, today's applications in the graphical printing industry are well optimized and highly standardized (for example: PSO “Process Standard Offset”) both on process side and also on the printing materials. Every step and every part of the process may be harmonized. The same notion is observable in the painting industry. The today's paints are well modified for their respective application with the right coating process.

Another situation is found in the quite new market for Maskless/Non-overspray applications, especially for automotive or aerospace painting activities. Although there are some research activities in this field, unfortunately today a “ready-to-use system” is, until now, not commercially available. But there are potential technologies on the market, which optionally could be used with some modifications. Research activity of the present applicant yielded some promising results.

For the finding of a proper technology, it is very important to know for what application case it should be used in. Basically, there are two cases of high interest. First, the application of Wear Resistant Paint (WRP) on final top-coat on external surfaces (e.g., landing flaps) and second for decoration processes including application of technical markings on external surfaces of AC parts (e.g., Sharklets®, VTP).

In a research performed by the present applicant, two typical paint materials were successfully tested: Desothane HS CA 9100 (from PPG Aerospace) and the external paint system Alexit H/S Basecoat 411-22 (from Mankiewicz). For that reason, these two painting systems may act as a basis for the further technology research in this disclosure; however, this does not impede the usage of other paints/inks.

Desothane HS CA 9100/Alexit H/S Basecoat 411-22

Both paints are 2K-systems with a pot life from one up to two hours. The typical processing temperatures lie around 15-35° C. at a humidity of 50-80%. The paints are suitable for conventional air spraying and low pressure electrostatic applications. In case of Desothane HS CA 9100, it can additionally be applied by High Volume Low Pressure (HVLP) air spray, brush or roller if required. In Table 1 below, available technical data of the paint materials are shown. Next to these facts, an important aspect is the rheological analyzation of the paint. Especially what kind of flowing behavior the paints show, if they were, e.g., sheared? Many technologies have a quite small viscosity range in which they work optimal, so the viscosity could also be a limitation factor. For this reason both coatings materials were measured with the rheometer Physica UDS-200.

TABLE 1

| | Desothane | Alexit H/S Basecoat |
|---|---|---|
| | CA 9100 | 411-22 |
| Solid Content | — | ~55% |
| (volumetric) | | |
| Solid Content (mass) | — | ~74% |
| Density (fluid) | — | 1.4-1.9 g/cm³ |
| Flow Cup Viscosity | 28-43 seconds @ | 25-35 seconds @ |
| (ISO/4 mm) | 23° | 23° |
| Pot Life | 1 h @ 21°-25° | 2 h @ 23° C. |
| Processing Temperature | 15-35° C. | 15-30° |
| Recommended Dry Film | 50-150 μm | — |
| Thickness | | |

The test program comprises three parts. At first, the specimen will be sheared at low shear rates, for a homogenization, after that, the shear rate increases up to the highest rate, and finally then, this value will be hold for short time. In table 2, the complete test program is depicted.

TABLE 2

| | Part 1 | Part 2 | Part 3 |
|---|---|---|---|
| Measured Points | 3 | 10 | 3 |
| Time for each | 5 seconds | 5 seconds | 5 seconds |
| point | | | |
| Shear Rate | d(gamma)/dt = | d(gamma)/dt = | d(gamma)/dt = |
| | 2 1/s | 200 1/s log | 200 1/s |
| Temperature | 23° C. | 23° C. | 23° C. |

| | |
|---|---|
| Measuring | Plate-Cone MK233, Physica UDS-200 |
| instrument | |

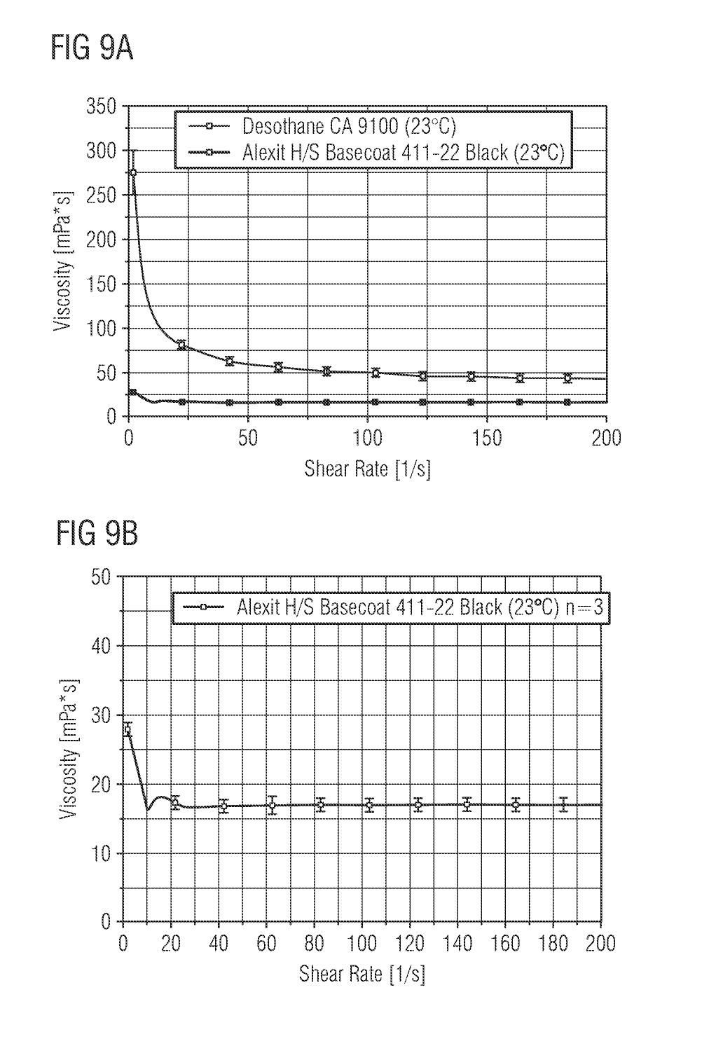

Both materials were tested three times. With the results, a mean curve with standard deviation was calculated. The shear rate range went, enduring the measurement, from 2 up to 200 reciprocal seconds. The test temperature remained at 23° C. for all tests. In FIGS. 9A and 9B, the flow curves for Desothane CA 9100 and for Alexit H/S Basecoat 411-22 Black are shown.

As is seen in FIG. 9A, the paint materials have two different flowing behaviors. Equally, the viscosity ranges differ distinctively. The wear resistant paint has a much higher viscosity value than the decoration basecoat. It starts around 275 mPas seconds contrary to the second paint material with just 27 mPas. Furthermore, the pseudoplastical flowing is even markedly stronger in the lower shear rates than on the other tested specimen. Only at an increasing of 25 reciprocal seconds in shearing, there is a drop of nearly 200 mPas. At the decorations basecoat Alexit this drop is quite less. It amounts circa 9 mPas.

In FIG. 9B, the viscosity curve of the tested Alexit H/S Basecoat 411-22 is zoomed in, for a better interpretation. Interestingly, from 20 up to 200 reciprocal seconds, Alexit shows a quasi-Newtonian flow, which is characterized by a horizontal straight curve. No shear thinning behavior is indicated.

User Requirement Specification

The investigations on the paint materials and the requirements by the user, gives a good scope and relevant information about which features for the maskless/non-overspray technology are strongly needed. For example, there may be a two component-paint-system. A good cleaning ability of the applicator (especially the fluid leading parts) and may be the presence of an “on-the-fly” mixing system could be an important aspect to make the right choice for a proper technology. With the rheological analyzation, a specific value yields for both paints, which can be used for the purposes of the present disclosure. So, “Drop on Demand”—Systems which only successful operate at very high viscosities like 10,000 mPas or even higher, can be rejected from the list for relevant technologies. Combining all these aspects, results in a user requirement specification for a suitable maskless/non-overspray technology with the following points, shown in the following table 3:

TABLE 3
User requirement specification for proper maskless/non-overspray
technology

| User Requirement Specification | Needed technical features |
|---|---|
| Applicability of current used | flexibility regarding usable viscosities |
| paints at Airbus | ranges (here 20 mPas-400 mPas), |
| | two component paints |
| Sharp edges/small details | suitable nozzle sizes for high |
| | resolution applications <1 mm |
| | (dependent on max. particle size of |
| | painting system), high precision + |
| | high repeatability of drop to drop |
| Non overspray | drop on demand technology with a |
| | precise droplet generation or a focused |
| | spray technique |
| Hiding power/covering ability | high volume flow rate application + |
| Stable and constant paint layer | precise droplet generation |
| thickness up to 100 μm | (monodisperse) + high repeatability |
| Inclusion in paint layer | high throughput technology (fast) + |
| | high frequencies + possibility of multi |
| | nozzle/applicator arrays |

Overview of Potential Technologies

In order of the user requirement specification, which was defined herein above, suitable Maskless Painting Technologies were evaluated. Each technology was reviewed under the aspects of their qualities, potentials and limitations concerning the desired application cases (e.g., WRP and decorative paints). Five technologies of this field were chosen. In that selection, we have a broad range from typical DOD technologies over to complete new developments. The five promising technologies are:
Inkjet Technology
Oscillated monodisperse droplet generation
Ultrasonic vibrating nozzle inkjet
Piezoelectric Jet Valve
Push-Out Fluid Ejecting (EPJet)

In the following we have a detailed look at each technology. The essential principles will be discussed.

Inkjet Technology (Using Applicator 102a)

The Inkjet technology is a non-impact printing method, which offers several features. Apart from the ability for high structural resolutions (up to 50 μm) and high speed applications (up to 100 m/min), inkjet technology can handle a myriad of functional fluids, like micro-emulsions, dispersions or Nano particular colloids, for example. The maximum droplet fly distance, to reach the full position accuracy, is mostly limited to a range in the vicinity of 2 to 5 mm between nozzle plate and substrate. Nevertheless, if a decorative motive or photo real picture (e.g., screened four color print—CMYK) is to be applied, the inkjet technology offers capabilities regarding complexity, speed and repeatability. If the decision is made for using this method, two different approaches are conceivable: One way could be to use conventional paints which are modified, especially in terms of viscosity and their particle size distributions. The other possibility is (if there is a strong need) to develop a complete new ink formulation for a specific application case, such as the above-disclose ink from Mankiewicz. In this approach, different base/clear coats suitable for industrial inkjet printer were developed. There are basically two types of Inkjet-systems available: Drop on Demand or Continuous Inkjet.

Drop on Demand (DOD):

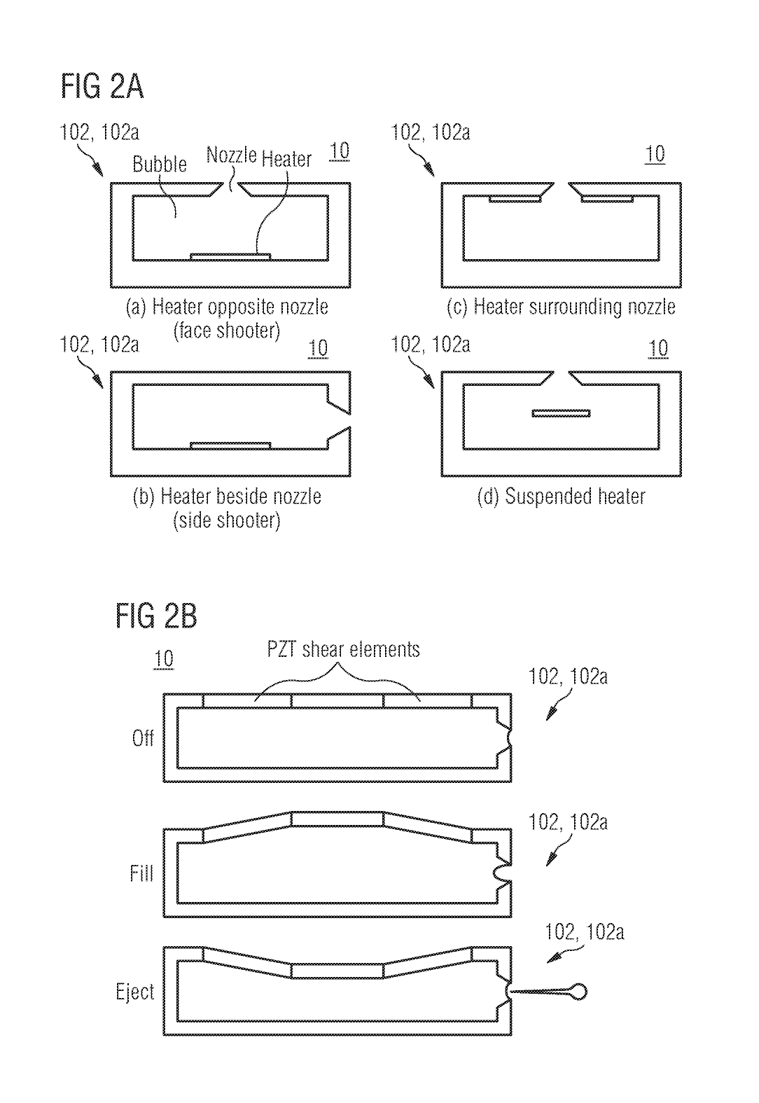

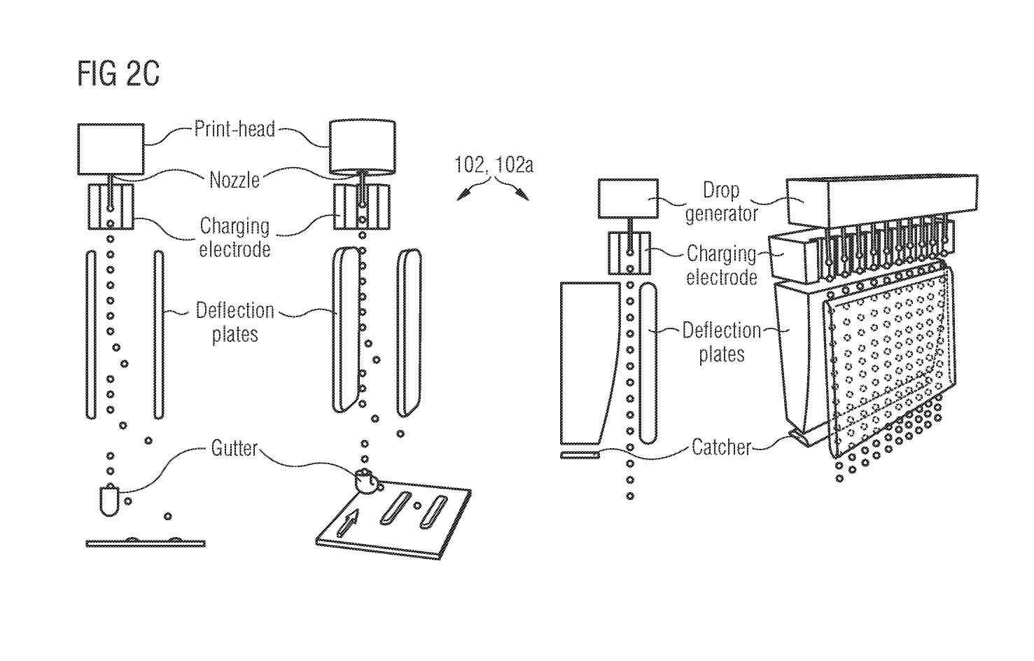

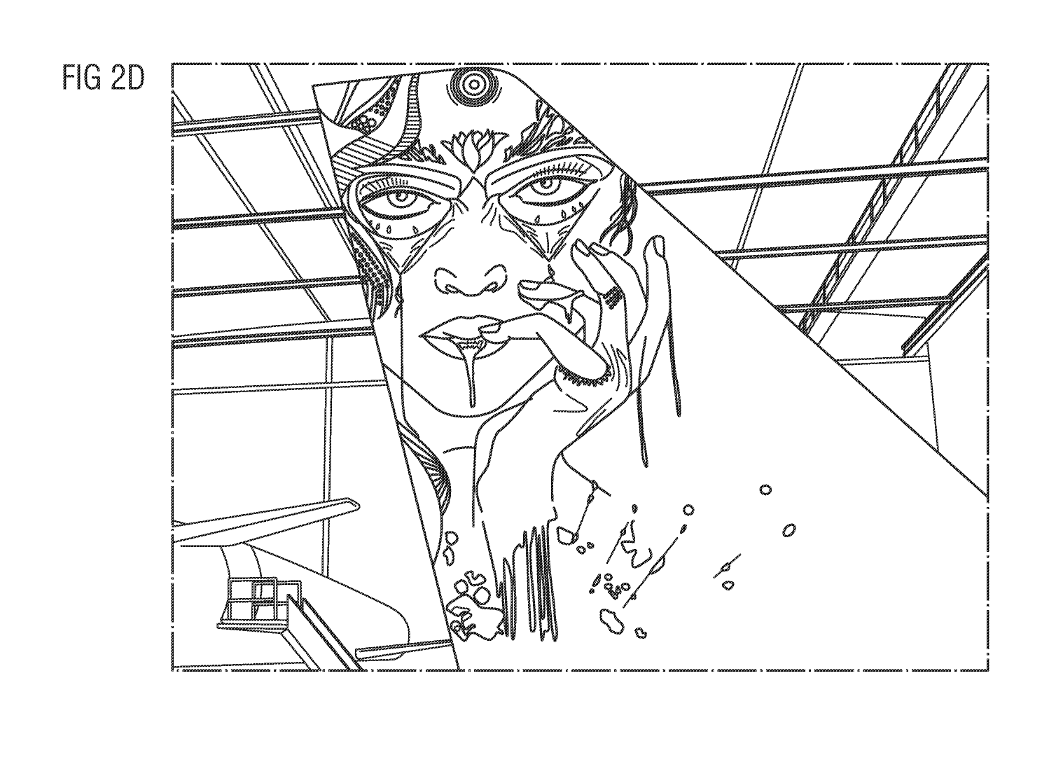

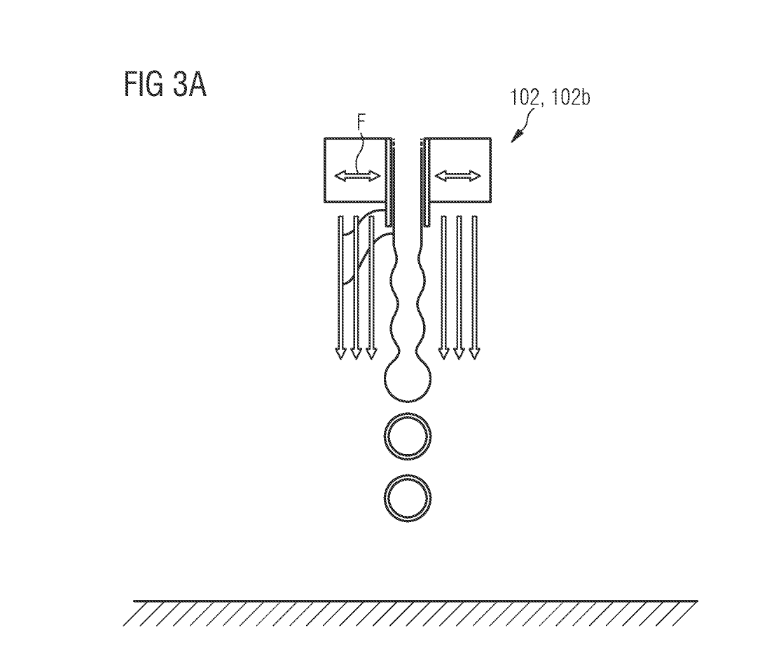

In DOD systems, there are two different functional principles. One type is the Thermal Inkjet (TIJ) and the other one is named Piezo Inkjet (Piezo-DOD). The TIJ is often called “Bubble Inkjet.” This is attributable to the fact that the droplet generation includes a heating step. In this step, the ink will be partly heated; this leads to a “steam” explosion with forming a bubble. This bubble causes a volume change and an increasing pressure in the ink chamber which finally propels a drop out of the chamber through the nozzle onto the substrate (seen in FIG. 2A).

Piezo-DOD-Systems work similarly (concerning the volume change) but with a difference: the volume change for the droplet generation is not attributable to a heating step, but to piezo driven effects (see FIG. 2B).

Continuous Inkjet (CIJ):

CIJ works with a continuous generated droplet jet, which comprises many small ink drops. A vibrating piezoelectric crystal creates an acoustic wave causing a stream of liquid to break into drops at regular intervals. These droplets pass a charging electrode which gives them a specific electrical charge on their surface. To make it happen, the ink must be sufficiently conductive (e.g., between 50 and 2000 Ωcm). Afterwards, the “charged” droplets fly through an electrical field (deflector plates). Depending on the electrical charge of the droplet, the degree of deflection varies. Uncharged drops will not deviate, while charged drops will be deflected by the field in proportion to the charge they carry. The deflection regulates which drop lands on the substrate and which one lands in a gutter. The principle of single and multiple CIJ are shown in FIG. 2C. The high working frequency of CIJ gives a good capability for high speed inkjet printing and the high drop velocity (50 m/s) and allows large application distances to the substrate. For this reason, CIJ is often used for markings processes in the packaging industry and is a valuable alternative (see the use case example in FIG. 2D).

Oscillated Monodisperse Droplet Generation (Using Applicator 102b)

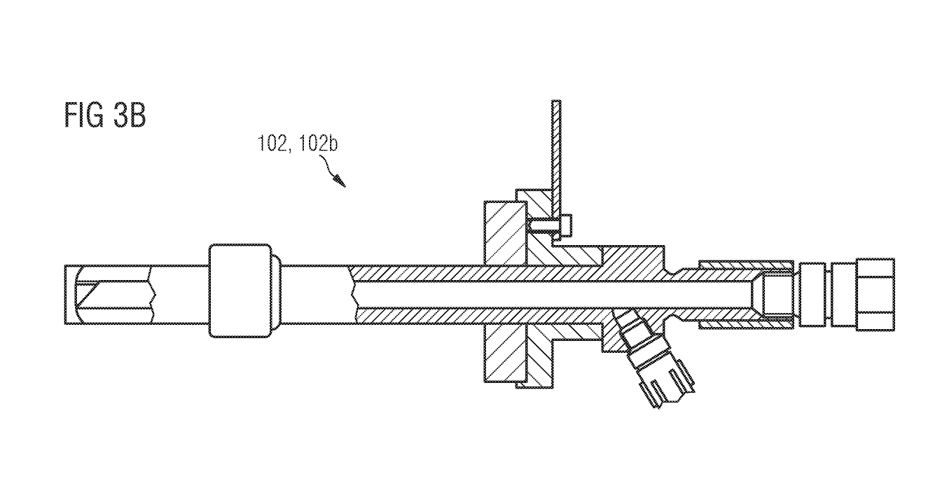

A new technology (regarding to paint applications) is the oscillated monodisperse droplet generation (OMD). This technology is based on the Rayleigh decay of laminar fluid jets. This mechanism is controlled by introducing vibratory disturbances by oscillation in fluid jets in order to generate droplets of known size. The big advantage is the strong repeatability in generation of same sized droplets (mono-disperse droplet size distribution) in contrast to typical spraying applications (many different droplet sizes in the spray). In FIG. 3A, the principle of function for the OMD technology is shown. Furthermore, in FIG. 3B, a schematic drawing of a droplet applicator 102b is shown.

The OMD technique is also used for technical applications in pharmacy or in metrology (production of polymer granulates; calibration of measuring devices). Since 2010 (start of the “Green Carbody Project”) up to now, an approach has been known for the development of a new Maskless Painting Method. The main application here is, to apply selective coatings for the automotive industry (different colored rooftops, hoods with decoration stripes, etc.).

An important aspect, which should be considered in this technology, is that OMD is not suitable for typical Drop on Demand applications. That means this device can't push out only a single droplet. When starting the oscillation, a droplet stream is generated. The only way to stop the stream, while the application runs, is to close the fluid path valve. Related to the “slow” closing times (compared with a inkjet piezo actuator) of this kind of valves, single drop-lets in specific short time sequences (˜1 ms) are not possible. For all-over selective coatings (like strips with sharp edges), this is not a criterion for exclusion, if the coating starts and ends with the component.

Ultrasonic Vibrating Nozzle Inkjet (Using Applicator 102c)

In this section, Ultrasonic vibrating nozzle inkjet-system (UVI) is depicted, which is an advancement of a technology called “vibrating orifice generator” (first commercialized vibrating nozzle drop generators were used for drug administering to the lung (inhalators) or for humidifier in printing shops. A novel approach of this technology has been presented; the main focus on the development lies especially on coatings in manufacturing processes in combination with high throughput inkjet deposition applications by using conventional paint systems. The inkjet process has been tested successfully with cellulose and two-part part polyurethane paints used for car and aircraft body manufacturing.

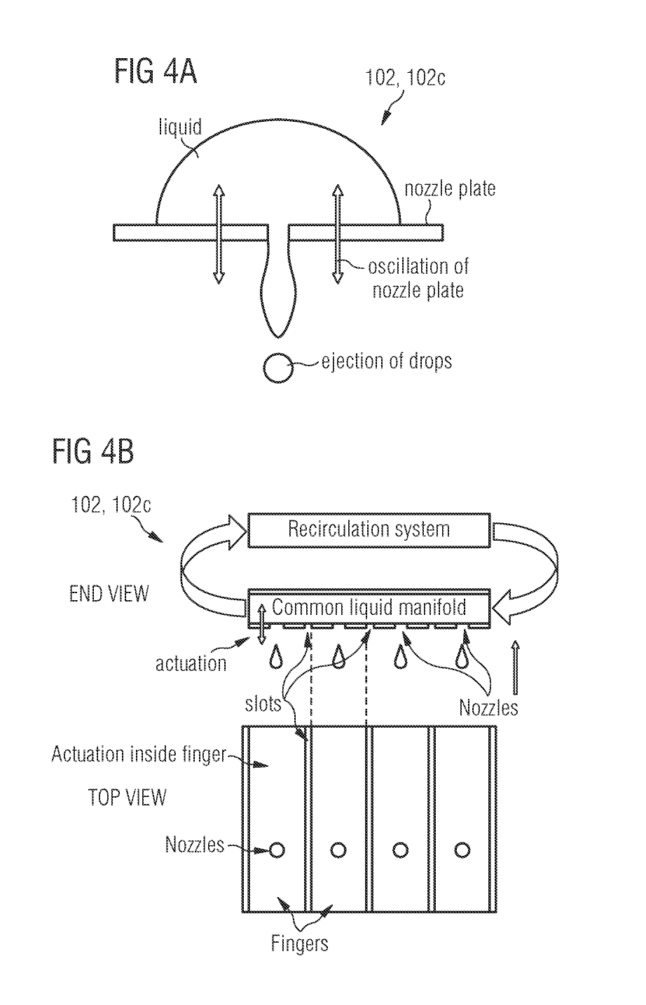

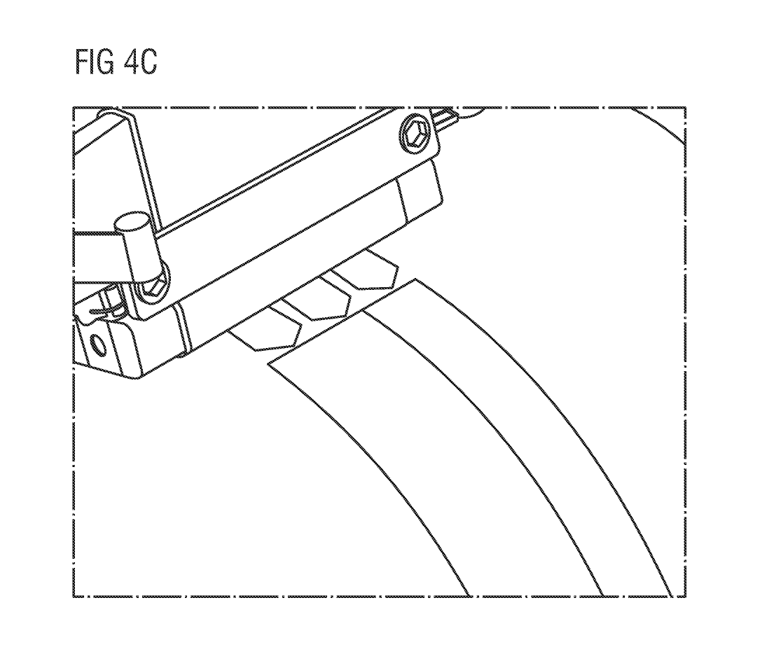

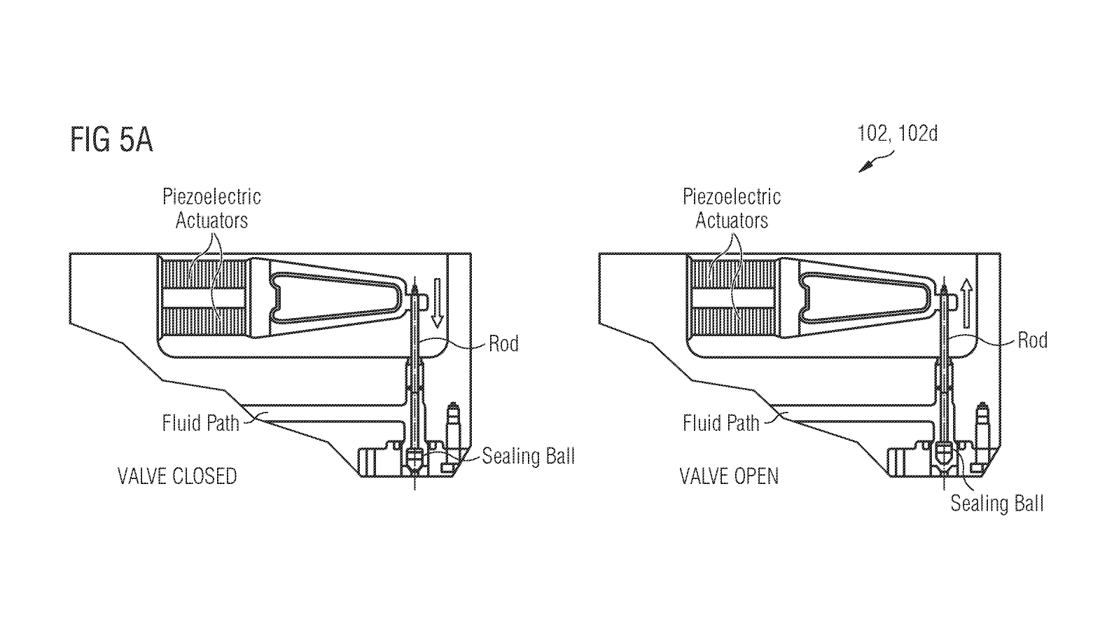

For this technique, as shown in FIG. 4A, an ultrasonic oscillation of a flexible membrane is used, which contains an array of nozzles. This technology is also quite similar to the former explained oscillated monodisperse droplet generator. The required energy to drive a drop ejection stems from the oscillation of the aperture. This fast movement causes an acceleration of the liquid in contact with the aperture, which generates a reaction force in form of a high pressure. This pressure causes a pulsating jet of liquid through the nozzle. After the moment of passing the nozzle, the outgoing stream breaks up uniformly into droplets. The drop size is directly controlled by the nozzle design (diameter) and by the oscillation frequency.

One of the main advantages of this technology resides in a higher throughput and a wider range of compatible liquids than with conventional inkjet methods regarding viscosity and maximum particle size (100 mPas—higher if shear-thinning; max. particle sizes 50 μm). In FIG. 4A, the drop ejection principle of the ultrasonic vibrating nozzle inkjet-system is shown.

Further, a schematic drawing of a UVI print head 102c, called Vista Inkjet, is depicted in FIG. 4B. As shown in FIG. 4B, the printhead comprises different parts: each nozzle is part of a “finger,” which will be actuated separately by a piezo element inside. Fine slits are placed on the nozzle plate between the nozzles to avoid mechanical cross-talk. The simple drop ejection principle, respectively the print head construction, brings some benefits. It allows an easily recirculation of the paint which aids to better self-cleaning and less clogging. Bigger particles in the fluids could be used, as well. In this respect, FIG. 4C shows the inkjet system printing conventional paints.

Piezoelectric Jet Valve (Using Applicator 102d)

Another interesting technology is the Piezoelectric Jet Valve (PJV) or

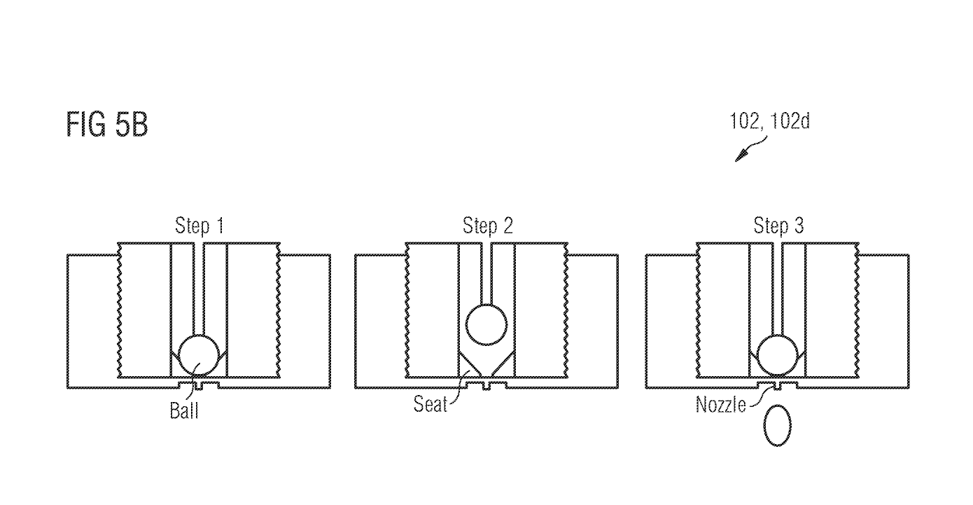

Jetting Dispensing Technology. Widely used in the electronic packaging industry to apply adhesive materials or solder pastes to different kind of substrates, like Printed Circuit Board (PCB) plates. Jetting Dispensing Technology developed very fast in recent years because of its ability to handle a great range of usable materials (by viscosities and particles sizes) and working at high frequencies up to 3000 Hz. This variability could be a big advantage for operation of conventional paint materials in maskless/non-overspray applications. A typical Piezoelectric Jet Valve 102d is shown in FIG. 5A. The device comprises basically a piezoelectric actuator, a rod with the sealing ball and a nozzle. The rod is mechanically connected to the oscillating actuator, so each movement will be directly transmitted to the sealing ball which opens and closes the nozzle like a valve.

As shown in FIG. 5B, the fluid application of the Piezoelectric Jet Valve 102d follows these steps: via the fluid path, a supply pressure will be applied and the whole volume around the ball-seat area will be refilled with the required medium. By moving the ball away from the seat, the fluid will be allowed to fill the seat area. The ball is then moved down rapidly with a known velocity to impact the seat of the nozzle. The fluid at the seat area is trapped by the down coming ball and finds its only exit path out the nozzle orifice. At this point the fluid pressure becomes extremely high and fluid is jetted out of the nozzle in a stream.

In dependence on volume, rheology and surface tension of the fluid, the stream decomposes into many equal-sized droplets or it contracts to one big drop. With the right frequency and a suitable fluid material, several hundred dots could be applied per second with a high repeatability.

Alternative Operated Jet Valves

At this point, it must be noted that beside the piezoelectric driven Jet Valves alternative actuation methods are available. Common variants for valve opening are operation by electromagnetic forces or pneumatics. The droplet generation principle is the same as with the piezo technology. So, the pros and cons for these applicators are also similar. The main differences reside in the lower ability for high switching frequencies (at pneumatic driven devices—around 300 Hz) and the problematic heating of the magnet coils (at electromagnetic driven devices) caused by high switching frequencies.

Push-Out Fluid Ejector (EPJet) (Using Applicator 102e)

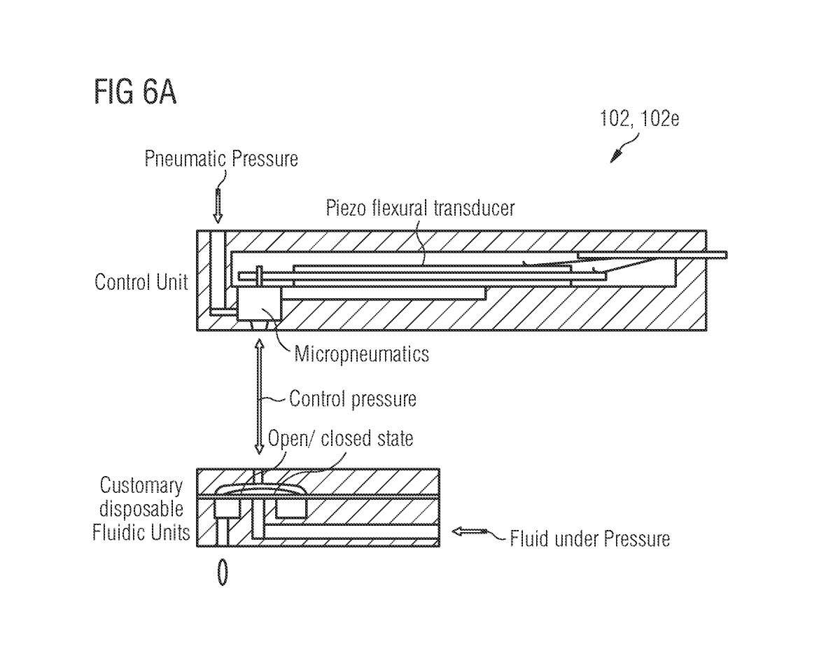

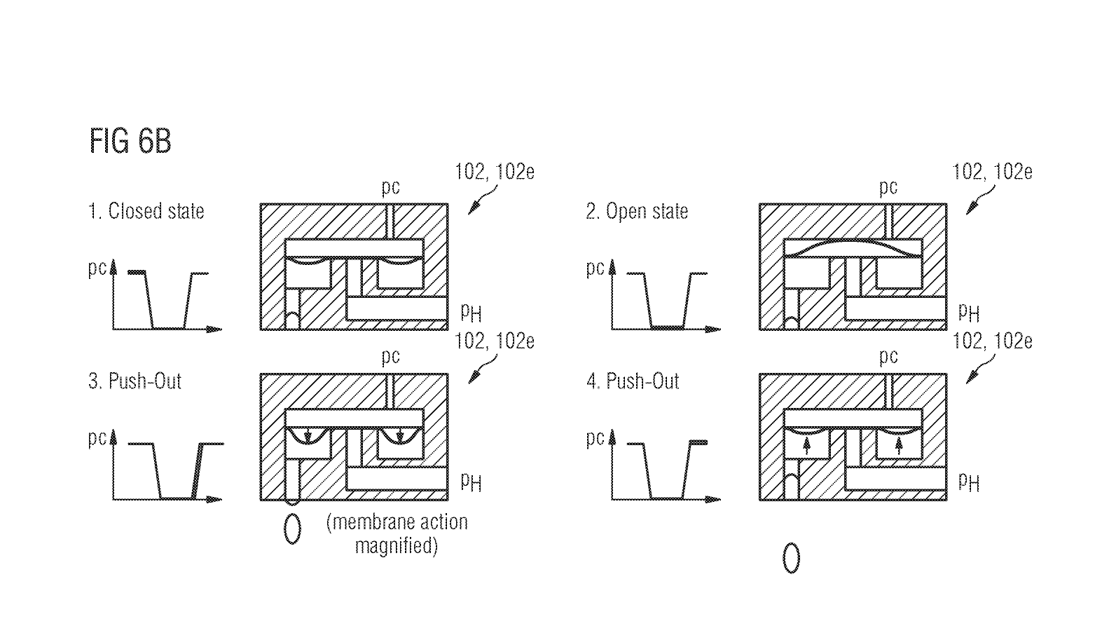

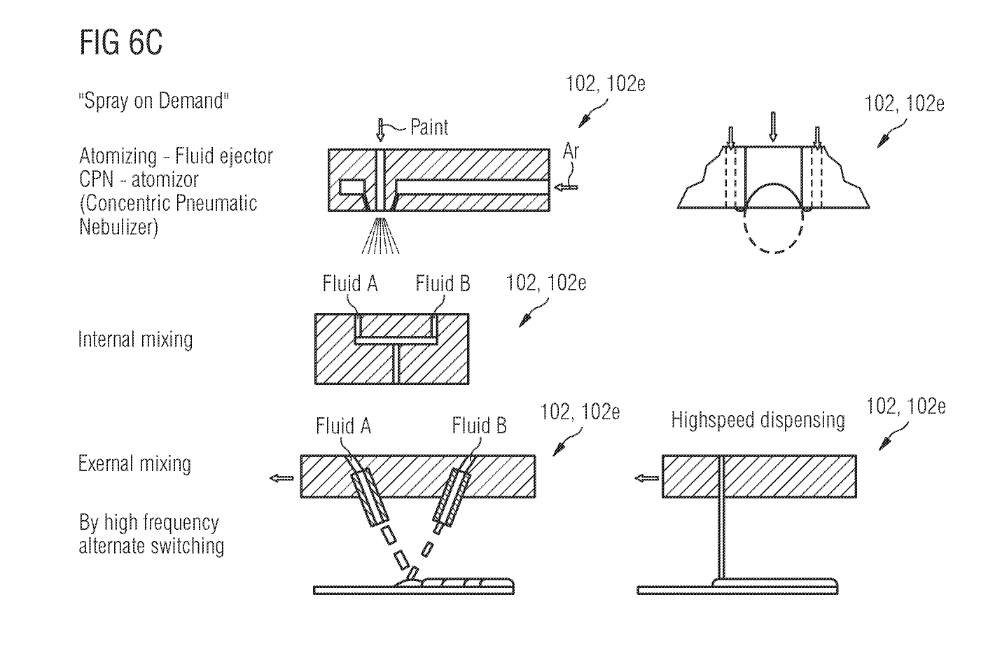

In the following, reference is made to a special Push-Out Fluid Ejector technology which is called EPJet. Right from the beginning, the main target of EPJet was to print highly viscous and thixotropic pigment-based paints. Therefore, rudiments have been used, which combine the principles of the jet valve dispensing and the inkjet technology. To obtain the required high kinetic energies for suitable drop generation of paints with high viscosity, a piezo-driven control valve (pilot valve) 102e has been designed, which has the ability to handle high switching times (frequency in kHz range) and regulate high pressures (up to 30 bars) at the same time. This “control unit” will be connected with a fluidic unit. In FIG. 6A, a schematic drawing of this applicator 102e is displayed.

The droplet generation with this device includes the following steps: in general, the pneumatic/control unit generates multiple highly transient, high energy pressure pulses. These pulses control the disposable fluidic unit, equipped with a DOD-dispenser, to eject droplets of controlled volume. A single droplet generation has four phases (seen in FIG. 6B). At first, the control pressure (pc) is high and the fluidic pressure (pFl) is quite low, and the fluidic unit assumes a closed state. Next, the pressure pc decreases below the fluid pressure, and this will deflect the membrane between the two pressure levels, and hence, an open state is obtained. The fluid chamber begins to fill, caused by the fluid pressure. After that, pressure pc rises again, and the membrane closes the fluid support. The pressure continues to increase in the fluid chamber and finally the fluid will be driven out very fast through the nozzle aperture and a droplet is created (push out stat). At least the control pressure ends at the initial level from the first state and process begins again.

According to used control pressure and nozzle geometry, dosing volumes are selectable in a wide range. A further interesting feature of this device resides in its customary disposable fluidic units. E-Painters could provide a wide range of different fluid ejectors. From a “Spray on Demand” over an internal/external mixing unit, for two component materials, over to classical high-speed dispensing, many different kinds of ejectors are possible (seen in FIG. 6C).

Alternative Technologies for Multi-Colored Coating Solutions

Finally, to close the cycle around the functional description of relevant technologies for Maskless Painting Applications, a short overview of additional alternative technologies for multi-colored coating solutions is given.

Powder Airbrush

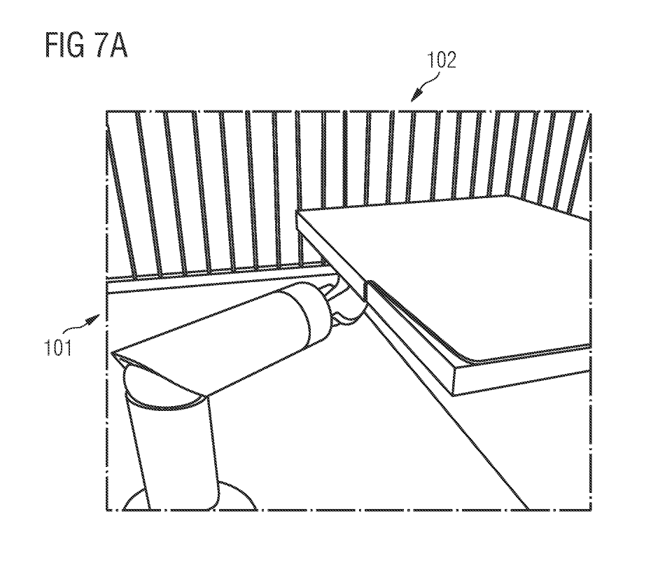

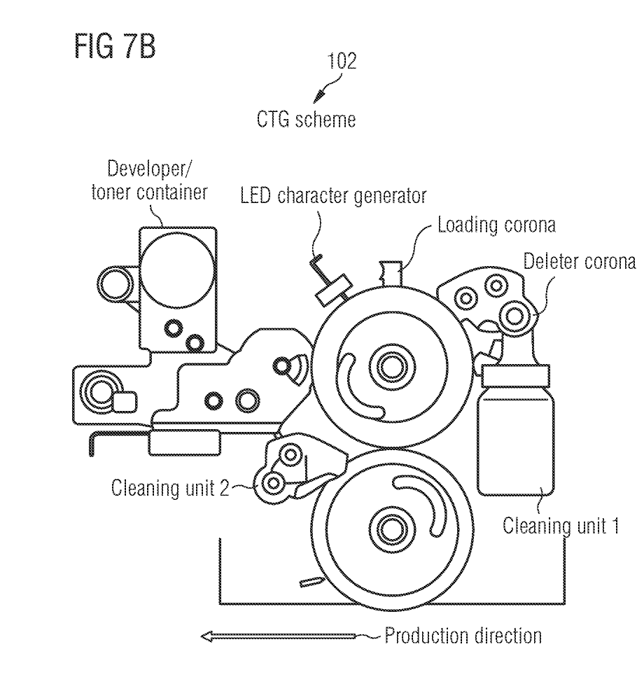

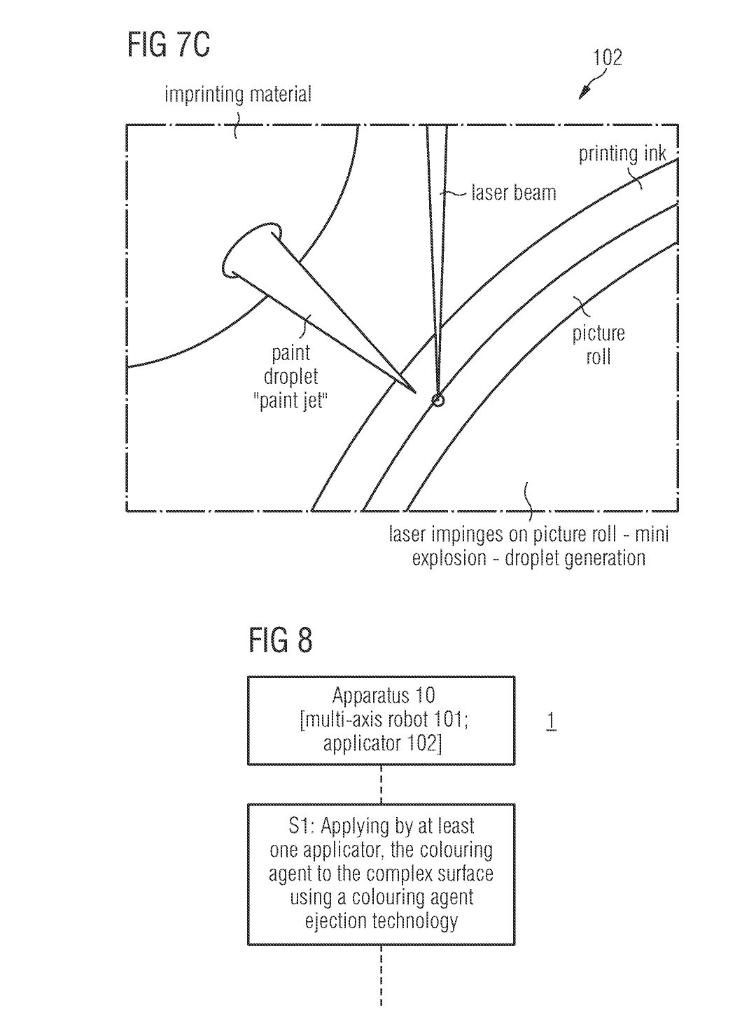

The Powder Airbrush technology is used for the targeted application of powder coating materials on a variety of substrate materials. Main item of this development is a special designed circular jet nozzle 102, which allows a precise punctual spray pattern. This property enables sharply contoured selective coatings with an uncertainty area smaller than 0.2 mm. In FIG. 7A, an example for typical use case of the powder airbrush is shown.

Electrophotography

Another example for an innovative selective coating technology is the Electro-photography process. Originally, a suitable fast and efficient printing technique for the decorative coating of glass materials in architectural use cases was intended. Today, a wide field of different industrial areas (coating interior, exterior big and small parts) is covered. The technology enables the possibility of decorative coatings, based on CMYK prints, directly on nearly any kind of material (metal, glass, ceramics, stone and plastics). One big advantage of the method is the high resistance of the applied coatings against abrasive, chemical, temperature and UV influences, which predestinates it for outdoor applications. In FIG. 7B, the principle of the electrophotography process is shown.

LaserSonic Technology

The LaserSonic Technology, is a kind of laser induced forward transfer process (LIFT process). This means that the transfer of paint materials will be induced with the help of a focused laser beam. The beam is directed onto a wet paint film surface. The energy of the laser generates a steam bubble in this paint film, which leads finally to an explosion and a paint droplet propels away onto the printing substrate. In FIG. 7C, the schematic principle is depicted.

A feature of this process is the ability of printing a wide range of different fluid materials. From conventional gravure or flexographic inks over to paintings and functional materials (like conductive inks) are usable with this technique. For that reason a large field of different applications is feasible.

Evaluation

Based on the selection in the above-described disclosure, the main objective here is to establish a suitable catalogue of requirements and technical specifications. Especially information about a possible usage for application cases like decorative coating or WRP painting are in focus. Therefore, four different main categories were evaluated. These main categories attend to the topics material, layer properties, application performances and possible application fields. Each category has their detailed requirements and their technical criteria, respectively, which should help to classify the technologies in the whole field.

There are quite significant differences between the various technologies. After a detailed evaluation of the complete selection, there are three highly promising technologies available regarding the defined application cases. These technologies are:
Piezoelectric (Magnetic) Jet Valve Technology,
EPJet Printer, and
Vista Inkjet Technology

All these techniques are in general micro-dosing applicators. This technology type brings some additional benefits for a use in maskless painting applications.

Beside the ability to handle the required viscosities and pigment sizes, these technologies stand out because of their high flexibility regarding the usable fluid materials and their application performance (ability for DOD, bigger applicator distances possible, etc.). No additional rheological or material modifying process of the paint materials is needed, compared to the inkjet technology, for example.

As seen above, the present disclosure enables one or more of the following advantages:
Weight reduction
Lead time reduction by maskless decoration and paint application process
Reduction of material consumption
Reduction of man hours
Reduction of environmental impact (Volatile Organic Compound (VOC) reduction)

It is believed that the advantages of the technique presented herein will be fully understood from the foregoing description, and it will be apparent that various changes may be made in the form, constructions and arrangement of the exemplary aspects thereof without departing from the scope of the present disclosure or without sacrificing all of its advantageous effects. Because the technique presented herein can be varied in many ways, it will be recognized that the present disclosure should be limited only by the scope of the claims that follow.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An apparatus for automated maskless painting of an external paint on a complex surface using a coloring agent, wherein the complex surface is part of an aircraft, comprising:
a multi-axis robot comprising at least one applicator for the coloring agent; wherein
the at least one applicator is configured to apply the coloring agent to the complex surface using a coloring agent ejection technology.

2. The apparatus according to claim 1, wherein the applicator is one of
an electrostatic spray gun, or
a rotary-bell spray painting applicator.

3. The apparatus according to claim 1, wherein the at least one applicator comprises a plurality of applicators mounted in parallel to one another.

4. The apparatus according to claim 1, wherein the coloring agent is one of paints or inks.

5. The apparatus according to claim 1, wherein the external paint is one of:
an external primer,
a base coat,
a topcoat,
a decoration coating,
a clear coat,
a functional coating, or
a wear resistant paint on a final top coat.

6. The apparatus according to claim 1, wherein the part of the aircraft is one of:
a vertical tail plane,
a flap,
at least a portion of the fuselage of the aircraft,
at least a portion of a wing of the aircraft, or
at least a portion of a nacelle of the aircraft.

7. The apparatus according to claim 1, wherein the coloring agent ejection technology is a piezoelectric jet valve technology.

8. The apparatus according to claim 1, wherein the coloring agent ejection technology is a flush-out fluid ejecting technology.

9. The apparatus according to claim 1, wherein the coloring agent ejection technology is an inkjet technology.

10. The apparatus according to claim 1, wherein the coloring agent ejection technology is an oscillated monodisperse droplet generation technology.

11. The apparatus according to claim 1, wherein the coloring agent ejection technology is an ultrasonic vibrating nozzle inkjet technology.

12. A method for automated maskless painting of an external paint on a complex surface using a coloring agent, wherein the complex surface is part of an aircraft and wherein a multi-axis robot comprising at least one applicator for the coloring agent is used, the method comprising the step of:
applying, by the at least one applicator, the coloring agent to the complex surface using a coloring agent ejection technology.
